(19) United States
(12) Patent Application Publication
(10) Pub. No.: US 2025/0245454 A1
(43) Pub. Date: Jul. 31, 2025

(54) PROTECTIVE COVER, LISTENING BOX AND METHOD OF OPERATION FOR A LISTENING BOX

(71) Applicant: Tiger Media International GmbH, Hamburg (DE)

(72) Inventor: Till WEITENDORF, Hamburg (DE)

(73) Assignee: Tiger Media International GmbH, Hamburg (DE)

(21) Appl. No.: 19/041,127

(22) Filed: Jan. 30, 2025

(30) Foreign Application Priority Data
Jan. 30, 2024 (DE) 102024102646.4

(51) Int. Cl. G06K 7/10; H04R 1/02

(52) U.S. Cl. CPC G06K 7/10297; H04R 1/02; H04R 2201/02

(57) ABSTRACT

A protective cover (1) for a listening box (2), which preferably at least partially surrounds the listening box in a closely fitting and protective manner and which contains an NFC chip (4) having an identifier that can be read by an NFC reading unit of the listening box (2). The NFC reading unit is operatively connected to a controller of the listening box (2) in order to influence operation of the listening box (2), in particular the selection of media content and the reproduction thereof, based on the identifier.

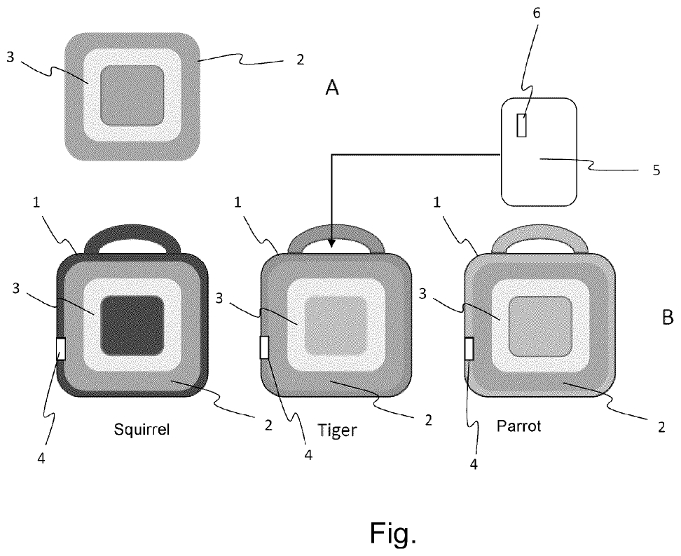

### INCORPORATION BY REFERENCE

This application claims priority from German Patent Application No. 10 2024 102 646.4, filed Jan. 30, 2024, which is incorporated herein by reference as if fully set forth.

### TECHNICAL FIELD

The invention relates to a protective cover, e.g. made of silicone or a similar material which is safe for children, on or for a listening box, which can adapt the operation and/or appearance of the listening box.

The invention also relates to a listening box and a method for operating a listening box.

### BACKGROUND

A listening box (“box” for short) is a technical device that can establish a (wireless) Internet connection in order to download digital media content, in particular spoken stories, audiobooks, radio plays or music, from a data server and output it via loudspeakers or headphones. The known tigerbox from the applicant is one such device.

Given appropriate configuration, such a device is intended for use by (small) children, who like to personalize the box in the style of a toy or cuddly toy. This aspect is intended to be used or even reinforced by the present invention.

Especially with small children, the box can be damaged as a result of being dropped, which preferably needs to be prevented.

In addition, the different boxes of different children should be prevented from being confused with one another.

### SUMMARY

For this purpose, the proposal is to provide the box with a protective cover, that is to say a kind of jacket, as defined in more detail in the description and claims that follow. The protective cover preferably does not surround the box completely, so that in particular a display (touch screen) and the loudspeaker (at least for the most part) remain free.

An inventive protective cover for a listening box, which preferably at least partially surrounds the listening box in a closely fitting and protective manner, contains an NFC chip having an identifier that can be read by an NFC reading unit of the listening box. The NFC reading unit is operatively connected to a controller of the listening box in order to influence operation of the listening box, in particular the selection of media content and the reproduction thereof, on the basis of the identifier.

The protective cover can thus ensure that the operation of the listening box, in particular as far as the selection of media content and the reproduction thereof are concerned, matches or is matchable to the protective cover on the basis of an appearance of the protective cover, in particular with regard to a color or other recognizable quality of the protective cover.

Additionally, the protective cover protects the box from damage and ensures that identical boxes are distinguishable.

The protective cover preferably has an animal shape with a predominant color, e.g. an orange tiger, so that a predominant readout color in the display of the box is then preferably orange and the media content undergoes appropriate (content) orientation, e.g. by way of a tiger's roar or the appearance of a tiger character.

In particular, the protective cover can be used to take the identifier as a basis for changing a readout on a display of the listening box, which has already been pointed out. The change may relate purely to color but also to content (depicting a tiger's face or the like).

The NFC reading unit of the listening box may most preferably also be designed to read a further identifier from a further NFC chip, in particular from an NFC card, as is generally known from the tigerbox. The controller of the listening box, which can include a processor and memory, is accordingly designed to control the operation of the listening box, in particular the selection of media content and the reproduction thereof, on the basis of a combination of the identifier and the further identifier.

In this context, “combination” means that the two identifiers only trigger a specific operating variant of the box together: e.g. a tiger protective case having the applicable identifier together with a time card (having the applicable further identifier) causes a tiger to explain the clock or “read out” the time.

According to the invention, the listening box comprises a protective cover, as described in detail above.

Preferably, the listening box additionally comprises a display, as also described in detail above.

Preferably, the listening box further comprises an identification carrier in the form of an NFC chip, in particular as part of an NFC card that can be inserted into a slot on the box.

An inventive method for operating a listening box comprises:
at least partially covering the listening box with the protective cover described above;
reading the identifier of the NFC chip by way of an NFC reading unit of the listening box, the NFC reading unit being operatively connected to a controller of the listening box; and
operating the listening box, in particular to select and reproduce media content, as specified by the controller on the basis of the identifier.

One configuration of the method provides for the operation of the listening box, in particular the selection of media content and the reproduction thereof, to be matched to the protective cover on the basis of an appearance of the protective cover, in particular with regard to a color or other recognizable quality of the protective cover.

Another configuration of the method provides for the identifier to be taken as a basis for changing a readout on a display of the listening box.

Yet another configuration of the method provides for the NFC reading unit of the listening box to read a further identifier from a further NFC chip, in particular from an NFC card, in particular by means of the NFC reading unit. The controller of the listening box then controls the operation of the listening box, in particular the selection of media content and the reproduction thereof, on the basis of a combination of the identifier and the further identifier.

### BRIEF DESCRIPTION OF THE DRAWINGS

The FIGURE shows a nonlimiting possible embodiment of the invention in two (partial) images A, B.

### DETAILED DESCRIPTION

Image A shows a listening box 2 having a display (light grey) 3 and a random neutral content, here e.g. with a screensaver or an audiobook in the readout.

The product in image A can now be covered with specific clothing or protective packaging, here e.g. protective sleeves (protective covers) 1, for the purpose of protection or beautification, as shown in image B. The sleeves 1 can correspond e.g. to animals, without restriction. The red sleeve 1 (left) could be e.g. a squirrel, the orange sleeve 1 (middle) a tiger, and the yellow sleeve 1 (right) a parrot.

Each of the sleeves 1 incorporates an NFC chip 4 with an identifier, which provides the system (that is to say the box 2 and possibly a server (not shown) operatively connected to the box 2) with a signal indicating which animal should appear in the display 3 when an NFC reading unit (not shown) of the box 2 reads the identifier. If the sleeve is e.g. the orange tiger protective cover, the tiger is seen. The box 2, or the server, provides the relevant media content.

The tiger can now interact with the child, is controlled by an Al, inter alia, and solves everyday “problems” together with the child, but also informs the child about the latest stories available on the box 2, or the server.

The box 2 can interact in a known manner with other identification carriers 5, e.g. cards, that also have an NFC chip 6 with a further identifier.

If e.g. a “teeth brushing card” 5 is inserted into the box 2 or otherwise put together with it so that the NFC reading unit of the box 2 can read the identifier of the chip 6, the tiger will brush its teeth together with the child and teach it with teeth brushing songs and brushing explanations. The media content that is output by the box 2 is thus coordinated with a combination of the two identifiers (tiger cover 1+teeth brushing card 5).

The same happens when a “time card” is inserted. The time can be read from the display 3, but the tiger also reads out the time to the child or explains how the clock works.

“News cards” in collaboration with TV or children's channels can also be implemented in this way, or the box 2 can use “contact cards” to set up communication (via the Internet) with parents etc. In each case, this is presented to the child by their “tiger friend”, the parrot or the squirrel, depending on the protective cover 1 used.

Alternatively, a user menu of the box 2 can also be used to select and assign the animal friend if e.g. the NFC connection between the box 2 and the protective cover 1 is not available or does not work.

1. A protective cover (1) for a listening box (2), comprising:
a sleeve that at least partially covers the listening box; and
an NFC chip (4) having an identifier that can be read by an NFC reading unit of the listening box (2), the NFC reading unit being operatively connected to a controller of the listening box (2) in order to influence operation of the listening box (2) based on the identifier.

2. The protective cover (1) as claimed in claim 1, wherein the operation of the listening box (2) matches or is matchable to the protective cover based on an appearance of the protective cover (1).

3. The protective cover (1) as claimed in claim 2, wherein the operation of the listening box (2) matches or is matchable to the protective cover based on a color or other recognizable quality of the protective cover (1).

4. The protective cover (1) as claimed in claim 1, wherein the identifier is adapted to cause a change in a readout on a display (3) of the listening box (2).

5. The protective cover (1) as claimed in claim 1, wherein the NFC reading unit of the listening box (2) is configured to read a further identifier from a further NFC chip (6), and a controller of the listening box (2) is configured to control the operation of the listening box (2) based on a combination of the identifier and the further identifier.

6. The protective cover (1) as claimed in claim 1, wherein the sleeve at least partially surrounds the listening box in a closely fitting and protective manner.

7. The protective cover (1) as claimed in claim 1, wherein the operation of the listening box is influenced for a selection of media content and a reproduction thereof.

8. A listening box (2) having the protective cover (1) as claimed in claim 1.

9. The listening box (2) as claimed in claim 8, further comprising a display (3).

10. The listening box (2) as claimed in claim 8, further comprising an identification carrier comprising an NFC chip (6).

11. A method for operating a listening box (2), comprising:
at least partially covering the listening box (2) with the protective cover (1) as claimed in claim 1;
reading the identifier of the NFC chip (4) by an NFC reading unit of the listening box (2), the NFC reading unit being operatively connected to a controller of the listening box (2); and
operating the listening box (2) as specified by the controller based on the identifier.

12. The method of claim 11, wherein operating the listening box (2) includes selecting and reproducing media content.

13. The method as claimed in claim 11, further comprising matching the operating of the listening box (2) to the protective cover based on an appearance of the protective cover (1).

14. The method as claimed in claim 13, wherein the appearance includes at least one of a color or other recognizable quality of the protective cover (1).

15. The method as claimed in claim 11, further comprising changing a readout on a display (3) of the listening box (2) based on the identifier.

16. The method as claimed in claim 11, further comprising
the NFC reading unit of the listening box (2) reading a further identifier from a further NFC chip (6); and
the controller of the listening box (2) controlling the operation of the listening box (2) based on a combination of the identifier and the further identifier.

17. The method of claim 16, wherein the reading of the further identifier from the further NFC chip (6) is via the NFC reading unit.

18. The method of claim 16, wherein the controlling of the operation includes selection of media content and reproduction thereof.
